(19) United States
(12) Patent Application Publication
(10) Pub. No.: US 2024/0017421 A1
(43) Pub. Date: Jan. 18, 2024

(54) MODULAR FORCE/TORQUE SENSOR SYSTEM

(71) Applicant: Dexterity, Inc., Redwood City, CA (US)

(72) Inventors: John McNelly, Campbell, CA (US); Jason Kmec, Redwood City, CA (US); David Smith, Ukiah, CA (US)

(21) Appl. No.: 18/222,952

(22) Filed: Jul. 17, 2023

Related U.S. Application Data
(60) Provisional application No. 63/390,264, filed on Jul. 18, 2022.

(51) Int. Cl. B25J 13/08; G01L 1/22

(52) U.S. Cl. CPC B25J 13/085; G01L 1/22

(57) ABSTRACT

A modular force/torque sensor system is disclosed. In various embodiments, a sensor interface device includes a first communication interface configured to receive an analog output associated with a sensor located remotely from the sensor acquisition device; a processor configured to use the analog output associated with the sensor to generate a sequence of discrete values derived from the analog output associated with the sensor; and a second communication interface coupled to the processor and configured to send at least a subset of the sequence of discrete values derived from the analog output associated with the sensor to a control module.

### CROSS REFERENCE TO OTHER APPLICATIONS

This application claims priority to U.S. Provisional Patent Application No. 63/390,264 entitled MODULAR FORCE/TORQUE SENSOR SYSTEM filed Jul. 18, 2022, which is incorporated herein by reference for all purposes.

### BACKGROUND OF THE INVENTION

Dexterous robots, e.g., for use in warehouses and other industrial/commercial settings, need a robust and low-cost force/torque sensor system that can be easily configured for a variety of applications with differing requirements for sensor axes and resolution.

Typically, force/torque sensors for robotic applications are relatively complex, expensive, fragile, and heavy, e.g., 6-axis force/torque sensors that include sensors and associated electronics in a single package. Failure of any component typically requires replacement of the entire sensor.

### BRIEF DESCRIPTION OF THE DRAWINGS

Various embodiments of the invention are disclosed in the following detailed description and the accompanying drawings.

FIG. 1 is a diagram illustrating an embodiment of a modular force/torque sensor system deployed on a robotic arm.

FIG. 2A is a diagram illustrating the internal structure of a 3-axis load cell used in some embodiments of a modular force/torque sensor system.

FIG. 2B illustrates a coordinate system used to transform three z-axis forces measured by the 3-axis load cell of FIG. 2A into total z-axis force and torque about x- and y-axes.

FIG. 2C illustrates a computation to transform three z-axis forces measured by the 3-axis load cell of FIG. 2A into total z-axis force and torque about x- and y-axes.

FIG. 3A is a flow diagram illustrating an embodiment of a process to provide sensor values to a control system.

FIG. 3B is a flow diagram illustrating an embodiment of a process to compute forces and/or torques based on received sensor values.

FIG. 4A is a diagram illustrating an embodiment of a 3-axis load cell used in some embodiments of a modular force/torque sensor system.

FIG. 4B is a diagram illustrating an embodiment of a 3-axis load cell used in some embodiments of a modular force/torque sensor system.

FIG. 5 is a diagram illustrating an embodiment of a sensor interface comprising a modular force/torque sensor system.

FIG. 6A is a block diagram illustrating an example of a configuration and use of a sensor interface in an embodiment of a modular force/torque sensor system.

FIG. 6B is a block diagram illustrating an example of a configuration and use of a sensor interface in an embodiment of a modular force/torque sensor system.

FIG. 6C is a block diagram illustrating an example of a configuration and use of a sensor interface in an embodiment of a modular force/torque sensor system.

FIG. 6D is a block diagram illustrating an example of a configuration and use of a sensor interface in an embodiment of a modular force/torque sensor system.

FIG. 7 is a diagram illustrating an example of a robotic end effector having load cells positioned in custom locations and/or orientations, in an embodiment of a modular force/torque sensor system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A modular force/torque sensor system is disclosed. In various embodiments, a simple robot sensor is positioned in a first location on a robotic arm or other robot, e.g., near a location at which a load is grasped or otherwise engaged and/or borne. The raw (e.g., analog) output of the sensor is sent via a cable or wireless communication to a sensor interface located remotely from the sensor. The sensor interface samples the analog or other raw output from the sensor and sends at least a subset of the readings to a control process via a network interface, e.g., EtherCAT. In various embodiments, separating the simple, more durable components of the sensor from the more fragile electronic components comprising the sensor interface enables the latter components to be placed in a location that reduces exposure to one or more of electromagnetic noise, mechanical vibration, traumatic impact, etc.

In various embodiments, a modular sensor system as disclosed herein may provide one or more of the following:
Sensor solution provides a high (e.g., multi-kHz) sample rate of forces and torques on a robot end effector with sufficient resolution for robotic picking applications.
   Measures both positive and negative forces/torques (tension/compression of the sensing element).
Sensor solution is immune to common sources of unwanted noise in an industrial use case.
   Sensor rejects relevant forms of electromagnetic interference.
   Sensor rejects mechanical vibrations/interference outside the desired sensor bandwidth/range of interest.
Sensor solution is robust and low-cost.
   Capable of withstanding nominal load and overload events typically encountered in unstructured production environments (end effector collisions, overweight payloads, etc.).
   Producible with readily available components and low-cost manufacturing processes (e.g. no intricate flexures or micro-scale fabrication processes).
   Easy and affordable to repair or replace in the event of damage.
Sensor solution is easily customizable to a wide range of payloads, and provides multi-axis sensing of forces and torques in all axes of interest.

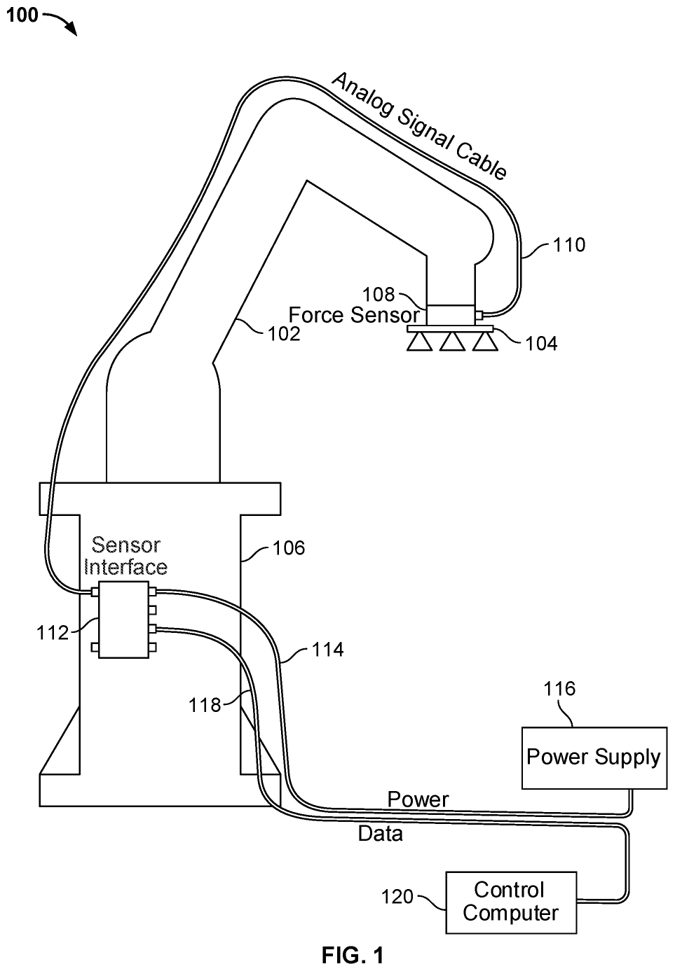

FIG. 1 is a diagram illustrating an embodiment of a modular force/torque sensor system deployed on a robotic arm. In the example shown, system 100 includes a robotic arm 102 having an end effector 104, in this example a suction-type gripper, and a stationary base 106. In other embodiments, robotic arm 102 may be mounted on a mobile chassis or other movable base. A force sensor module 108 is positioned between the robotic arm 102 and end effector 104, and passes analog signals via analog signal cable 110 to the sensor interface module 112 mounted on the base 106. Power is supplied via power cable 114 from power supply 116 which, in various embodiments, may be mounted on base 106 and/or at another nearby location. Data is passed from the sensor interface 112, in digital form, to the control computer 120 through a high-speed fieldbus interface 118, e.g., an EtherCAT interface.

In various embodiments, a modular force/torque sensor system as disclosed herein, such as system 100 of FIG. 1, includes three main components: a multi-axis load cell (e.g., 108), an analog signal cable (e.g., 110), and a sensor interface (e.g., 112), sometimes referred to herein as an “acquisition module”. In various embodiments, the multi-axis load cell contains three individual resistive sensing elements (load cells), arranged in an equilateral triangle. These load cells can be arranged in different orientations to sense various forces and torques of interest. Three common configurations, FzTxTy (i.e., force along z-axis and torque about x- and y-axes), FxFyTz (i.e., force along x- and y-axes and torque about z-axis), and custom, are used in various embodiments.

In the FzTxTy configuration, the three load cells (each comprising one or more strain gauges embodied in a PCB disposed on a substrate, e.g.) are arranged in an equilateral triangle, with the force vectors sensed by each load cell all oriented normal to the “top” plane of the load cell. Basic trigonometry is used to transform the three load cell forces, f0, f1, and f2, into a force along the z-axis (Fz) and moments (torques, T, also referred to as moments, M) about the x (Mx) and y (My) axes.

In the FxFyTz configuration, all three load cells are oriented in an equilateral triangle on their sides, such that their force vectors are spaced 120° apart and intersect at the origin (along the z-axis). Basic trigonometry is used to transform the three load cell forces f0, f1, and f2, into a force along the x-axis (Fx), a force along the y-axis (Fy), and a moment about the z-axis (Mz).

In various embodiments, a force/torque sensor system as disclosed herein includes force-sensing elements containing resistive (or other) load cells connected to a sensor interface module via a shielded cable (e.g., 110). In some embodiments, the analog signal cable comprises a twisted pair cable, e.g., an Ethernet (e.g., Ethernet Cat 5 or Cat 6) cable, connected to use twisted pairs comprising the cable to carry analog signals, supply DC voltage and/or sensing current, etc.). In some embodiments, the force sensor includes three resistive force sensors. Three twisted pairs of the analog signal cable are used to carry respective analog output of the three force sensors to the sensor interface. A fourth twisted pair is used to supply an excitation voltage from the sensor interface to the force sensors.

In various embodiments, analog signals are transmitted from the load cells via a standard shielded twisted pair Ethernet cable. The load cells utilized in the sensor, in various embodiments, use a Wheatstone bridge topology, which generates a differential analog signal across two sense wires for each load cell. Each of these sense wires is routed in the signal cable as a twisted pair, providing excellent immunity against most forms of common-mode electromagnetic interference.

In various embodiments, a control system, module, process, and/or computer, e.g., control computer 120 in the example shown in FIG. 1, uses sensor readings provided via sensor interface 112 and data cable 118 to compute forces and/or moments, as described above, to be used to determine a control action with respect to a robot, such as robotic arm 102 having end effector 104. For example, a z-axis force reading may be used to control the robotic arm 102 in a manner that does not damage an object the system 100 is attempting to grasp using end effector 104, and/or to determine that the object has been grasped successfully, and/or to place the object in a destination location, without damaging the object or adjacent items. In some embodiments, forces and torques computed by the control computer 120 may be used to place an object snugly next to adjacent items, such as to determine that one or more sides of the object being placed are engaged squarely or fully with an adjacent item or structure. In some embodiments, forces and torques computed by the control computer 120 may be used to provide a safe and/or compliant robotic system, such as one that stops moving and/or otherwise adjusts its behavior in response to detecting, based on computed forces and moments, that the robotic arm 102, end effector 104, and/or a grasped object has come in contact with an obstacle. In various embodiments, forces and torques computed by the control computer 120 may be used to perform any robotic control operation or function that depends, at least in part, on such force and/or moment (torque) information.

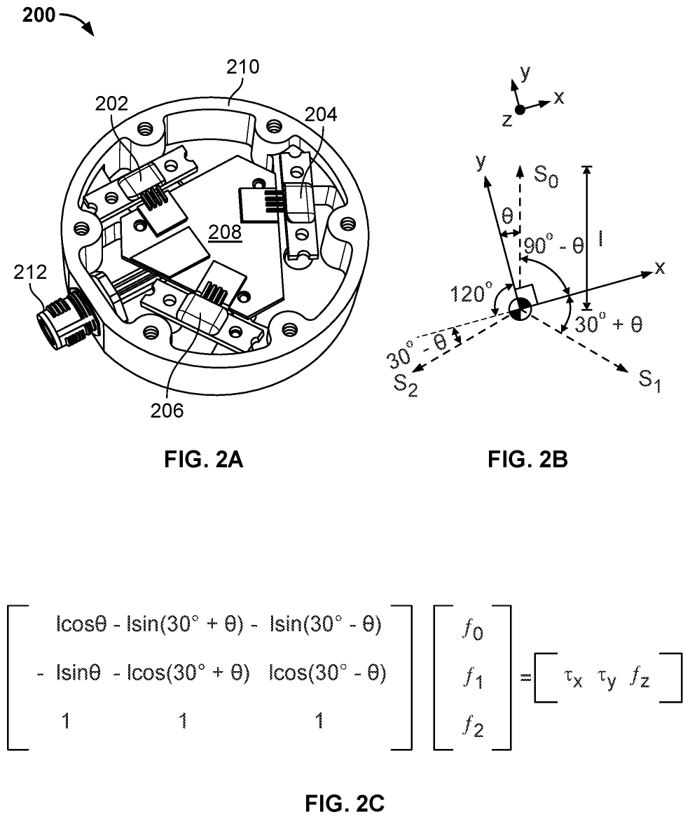

FIG. 2A is a diagram illustrating the internal structure of a 3-axis load cell used in some embodiments of a modular force/torque sensor system. In the example shown, three resistive sensing elements (load cells) 202, 204, and 206, are disposed on and/or adjacent to a PCB or other substrate 208 in positions that define respective corresponding sides of an equilateral triangle. The sensing elements 202, 204, and 206 and/or PCB or other substrate 208 are mounted in a sensor body 210. Traces or other electrical connections on PCB or other substrate 208 connect sensing elements 202, 204, and 206 to corresponding pins comprising electrical cable connector 212. Connector 212 is configured to receive a cable, such as analog signal cable 110 of FIG. 1, and to provide voltages received from a sensor interface, such as sensor interface 112 of FIG. 1, to the sensing elements 202, 204, and 206 and to provide analog sensor output values received from the sensing elements 202, 204, and 206 to the sensor interface 112, via the analog signal cable 110.

In the example shown in FIG. 2A, sensor body 210 contains three individual resistive sensing elements (load cells) 202, 204, and 206, that each transduce force along one axis. By arranging these load cells as cantilever beams in an equilateral triangle, as shown in FIG. 2A, three independent z-axis forces can be recorded at some lever arm distance l from the origin.

When summed together, these z-axis forces provide the total z-axis force f_{z} applied to the sensor. By calculating the torque enacted by each load cell's z-axis force about an arbitrary x and y axis centered in the middle of the sensor, an x-axis torque τₓ and a y-axis torque τ_{y} can be calculated.

FIG. 2B illustrates a coordinate system used to transform three z-axis forces measured by the 3-axis load cell of FIG. 2A into total z-axis force and torque about x- and y-axes.

FIG. 2C illustrates a computation to transform three z-axis forces measured by the 3-axis load cell of FIG. 2A into total z-axis force and torque about x- and y-axes. In various embodiments, the computation illustrated in FIG. 2C may be performed by a control computer, such as control computer 120 of FIG. 1, using sensor values received from a sensor interface, such as sensor interface 112.

Referring to FIGS. 2A, 2B, and 2C, because the x- and y-axes may be rotated arbitrarily relative to the position of the physical load cells (say, to line up with locating features on the exterior of the sensor puck, e.g., housing 210), a rotation angle θ is introduced to represent the counter-clockwise angle between the coordinate system y-axis and the vector from the coordinate system origin to the location of load cell S₀. This rotation angle is used in the transformation matrix from z-axis forces f₀, f₁, and f₂ to z-axis force f_{z} and x-axis/y-axis torques, Tx and Ty, as shown in FIG. 2C.

While FIG. 2C illustrates a computation used to determine z-axis force f_{z} and x-axis/y-axis torques, Tx and Ty, based on sensor output generated by a 3-axis load cell in which the load cells (e.g., 202, 204, and 206) are positioned and oriented as shown in FIG. 2A, in other embodiments, in which the load cells are positioned and/or oriented differently than as shown in FIG. 2A, those of ordinary skill in the art will recognize and know the trigonometry-based computations required to be performed to transform the load cell (sensor) output/readings to the force(s) and/or moment(s) needed to be provide to the robotic (or other) control system.

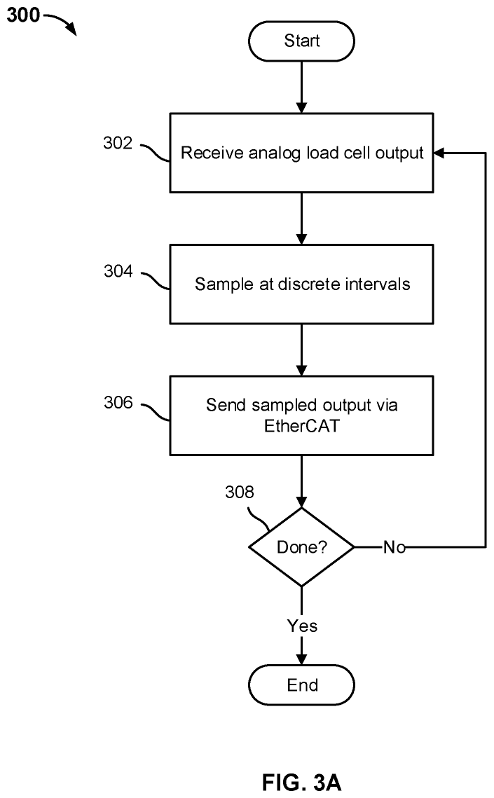

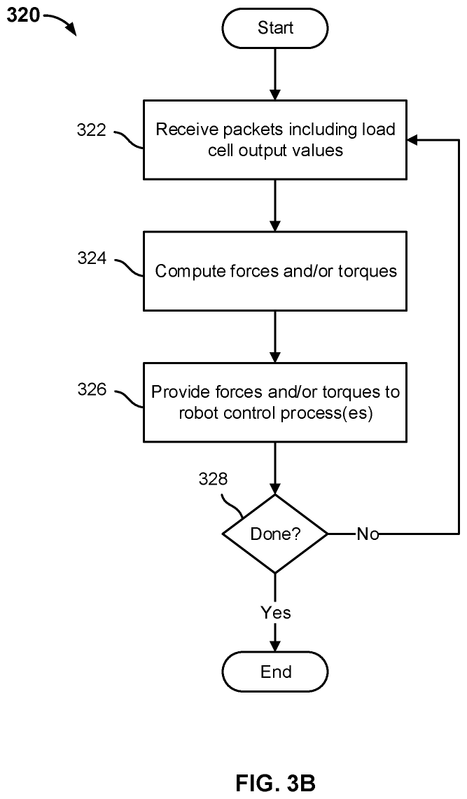

FIG. 3A is a flow diagram illustrating an embodiment of a process to provide sensor values to a control system. In various embodiments, the process 300 of FIG. 3A is performed by a sensor interface, such as sensor interface 112 of FIG. 1. In the example shown, at 302, an analog signal, e.g., comprising analog sensor output values, are received, e.g., via an analog signal cable such as cable 110 of FIG. 1. At 304, each of one or more received analog signals is sampled to provide a sequence of discrete sensor values. At 306, at least a subset of the sampled values is provided as output, e.g., via an EtherCAT or another digital interface. Processing continues, with subsequent iterations of steps 302, 304, and 306 being performed, until done (308), e.g., the system is paused or shut down.

FIG. 3B is a flow diagram illustrating an embodiment of a process to compute forces and/or torques based on received sensor values. In various embodiments, process 320 of FIG. 3B is performed by a control module, process, computer, etc., such as control computer 120 of FIG. 1. In the example shown, at 322, packets include load cell output values are received. At 324, the received values are used to computer forces and/or torques. For example, computations such as those illustrated in FIG. 2C may be performed. Corresponding sensor values from each of a plurality of load cells may be correlated, e.g., based on timestamps, sequence numbers, or other information included in or otherwise associated with the packets received at 322, and the computations performed to compute the force(s) and/or torque(s) of interest. At 326, the force(s) and/or torque(s) computed at 324 are provide as output to a robotic control process, such as one configured to use the computed force(s) and/or torque(s) to control a robotic arm or other robotic instrumentality. The process continues, with subsequent iterations of steps 322, 324, and 326 being performed, until done (328), e.g., the system is paused or shut down.

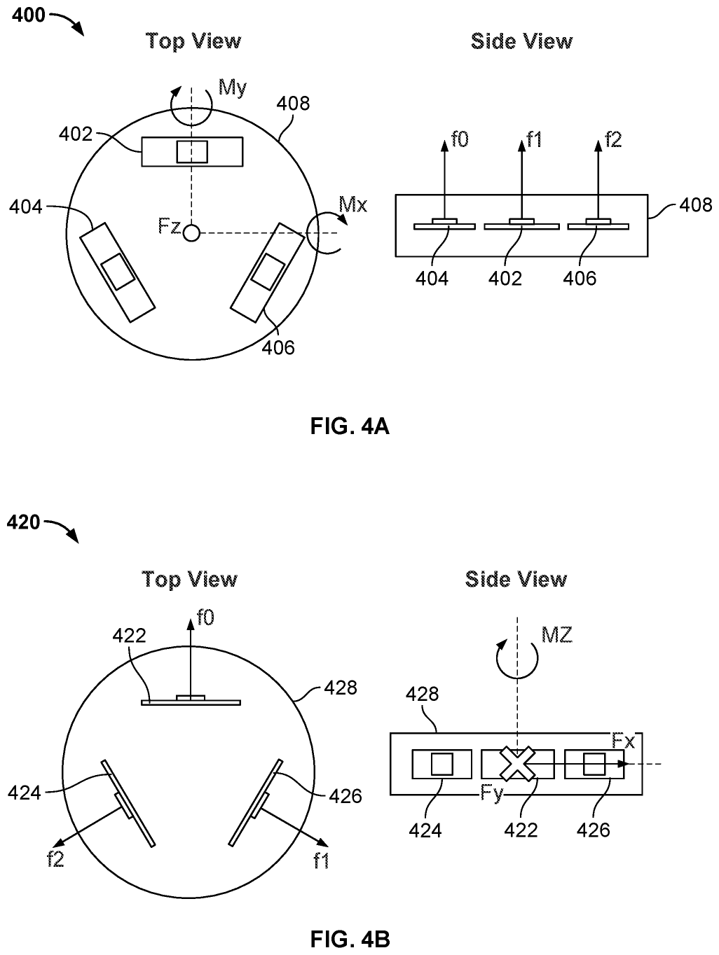

FIG. 4A is a diagram illustrating an embodiment of a 3-axis load cell used in some embodiments of a modular force/torque sensor system. In the example shown, three resistive sensing elements (load cells) 402, 404, and 406, are disposed on a PCB or other substrate 408 in positions that define respective corresponding sides of an equilateral triangle, as in the example shown in FIG. 2A. In various embodiments, the forces f₀, f₁, and f₂ sensed by the load cells 404, 402, and 406, respectively, are provided via a sensor interface, such as sensor interface 112 of FIG. 1, to a control computer, such as control computer 120 of FIG. 1, to be transformed by computation to provide forces and torques for robotic control, e.g., as described above in connection with FIGS. 2A, 2B, and 2C.

FIG. 4B is a diagram illustrating an embodiment of a 3-axis load cell used in some embodiments of a modular force/torque sensor system. In the example shown, three resistive sensing elements (load cells) 422, 424, and 426, are disposed on a PCB or other substrate 428 in positions that define respective corresponding sides of an equilateral triangle. The resistive sensing elements (load cells) 422, 424, and 426 are oriented on their respective sides, such that their force vectors are spaced 120° apart and intersect at the origin (along the z-axis), as in the FxFyTz configuration described above. In various embodiments, basic trigonometry is used to transform the three load cell forces f0, f1, and f2, into a force along the x-axis (Fx), a force along the y-axis (Fy), and a moment about the z-axis (Mz), as described above.

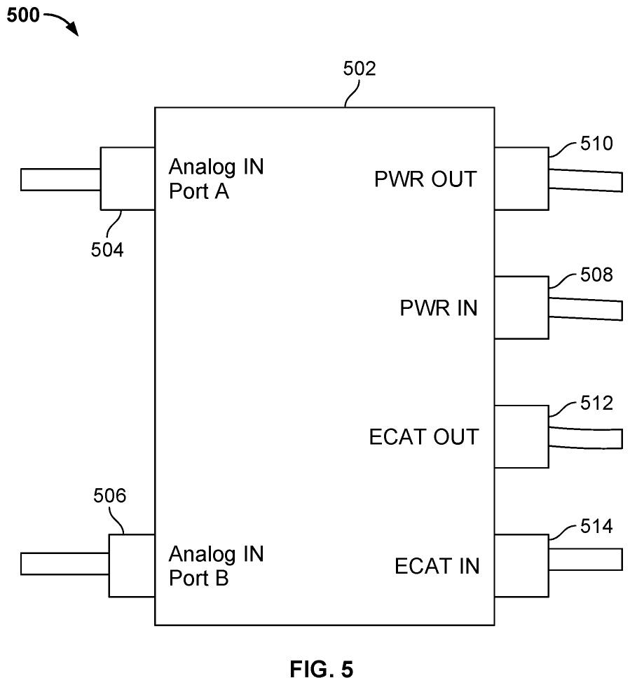

FIG. 5 is a diagram illustrating an embodiment of a sensor interface comprising a modular force/torque sensor system. In the example shown, sensor interface 500 includes a sensor interface body 502 having two analog ports 504, 506, a power in connector 508, a power out connector 510 (e.g., to provide power to another, chained sensor interface module), an EtherCAT out connector 512, and an EtherCAT in connector 514. The sensor interface body 502 houses electronics, not shown in FIG. 5, to sample analog signals received via analog ports 504 and/or 506 and provide discrete sensor output values via EtherCAT in connector/interface 514. Communications to control and/or interrogate the sensor interface 500 may be received via the EtherCAT in connector 514.

In various embodiments, a sensor interface/acquisition module as disclosed herein, such as sensor interface 500 of FIG. 5, reads up to 6 differential analog signals with a voltage range of 0-3.3V, and reports values over EtherCAT with an update frequency over 2 kHz. The device features programmable gain up to 128× on all differential analog inputs, and utilizes a passive differential filter network and hardware oversampling to reject unwanted noise.

Each input connector on the sensor interface (e.g., Ports A and B, 504 and 506, in the example shown in FIG. 5) features 3× differential signal pairs for reading analog voltages, as well as a pair of power wires (+3.3V and GND).

The sensor interface module (e.g., 500) contains electronics and firmware that read the analog values provided by the force sensor and transform these raw strain gauge (or other sensor) values into calibrated force and torque values that are reported over a high speed fieldbus network (e.g., EtherCAT) to the robot control system.

In various embodiments, the sensor interface module, sometimes referred to herein as an “acquisition module”, samples the analog values provided by the force sensors at a high rate, e.g., 2.3 kHz, and transform these raw strain gauge (or other sensor) values into calibrated force and torque values, e.g., by performing a lookup or applying another transform, such as a transformation matrix (e.g., see FIG. 2C). Different sensor configurations are associated with different transformation tables, in various embodiments. A custom arrangement of sensors may be provisioned by adding a transformation table or other data, functions, or structures to map sensor output to force/torque.

In various embodiments, the acquisition module supplies power to the load cells, reading the analog differential signals provided by the load cells, and transforming/relaying the measured sensor data over a network connection to the robot control system.

In various embodiments, each acquisition module can accept inputs from multiple multi-axis load cells, allowing one acquisition module to provide force sensor data for multiple systems, e.g., two multi-axis loads cells deployed on a single robotic arm and end effector, or a first multi-axis load cell on a first robotic arm and a second multi-axis load cell on a second robotic arm.

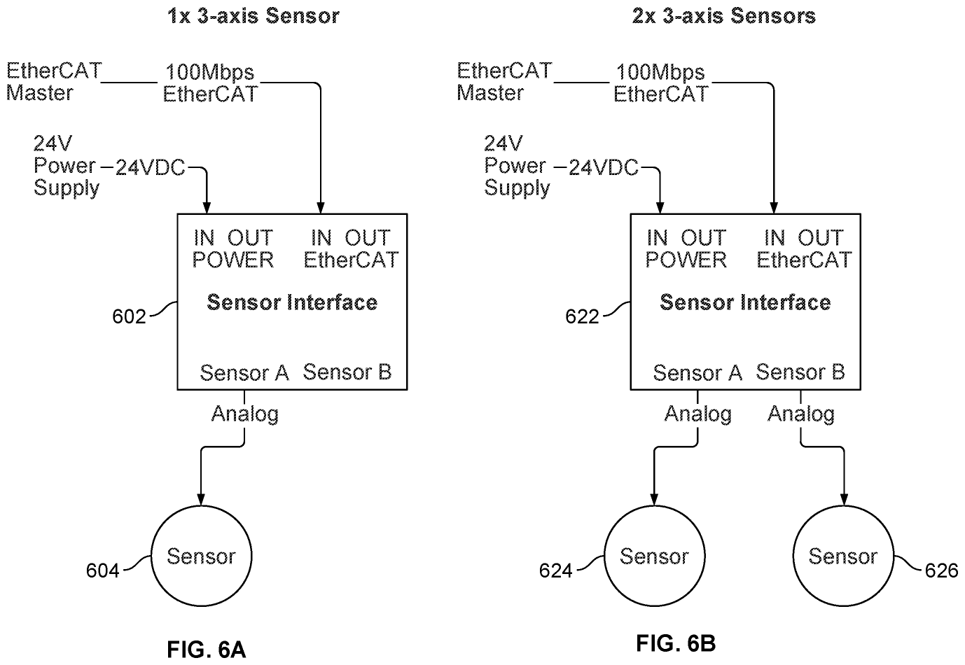

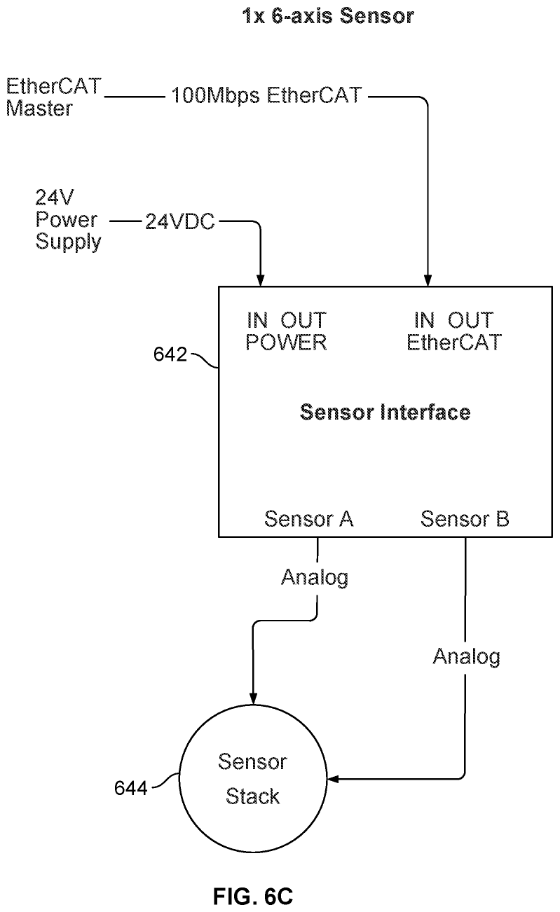

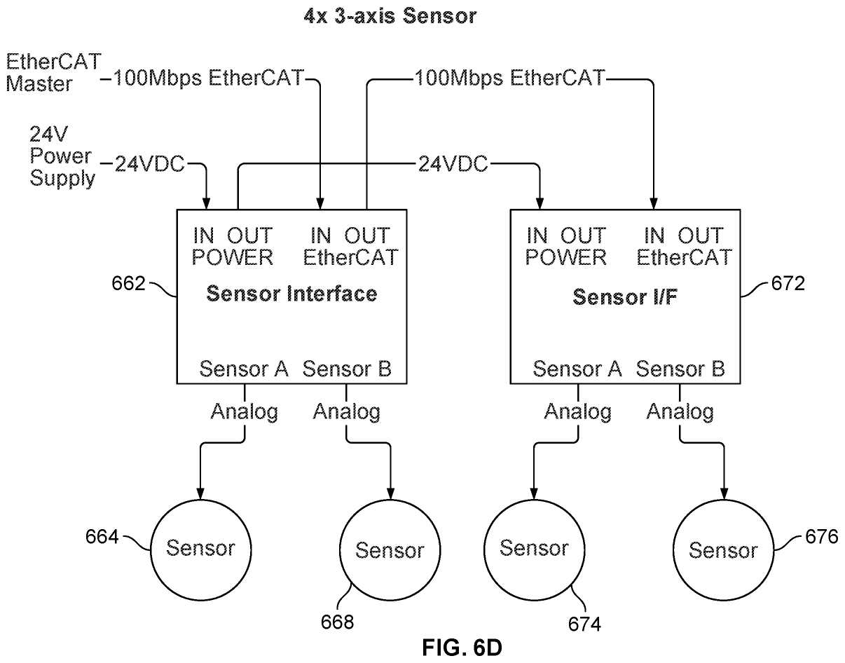

In various embodiments, a single acquisition module as disclosed herein can be utilized to instrument one or two three-axis load cells. This can provide 3-axis sensing for a single end effector, 3-axis sensing for two independent end effectors, or 6-axis sensing for a single end effector (see, e.g., FIG. 6C, described below).

FIG. 6A is a block diagram illustrating an example of a configuration and use of a sensor interface in an embodiment of a modular force/torque sensor system. In the example shown, sensor interface 602 is configured to receive and process analog signals from a single 3-axis load cell 604, e.g., on in the FzTxTy configuration described above.

FIG. 6B is a block diagram illustrating an example of a configuration and use of a sensor interface in an embodiment of a modular force/torque sensor system. In the example shown, sensor interface 622 is configured to receive and process analog signals from two 3-axis load cells 624, 626, each connected via a corresponding one of the sensor ports A and B of sensor interface 622. For example, sensor 624 may comprise a first 3-axis load cell in the FzTxTy configuration described above while sensor 626 may comprise a second 3-axis load cell in the FzTxTy configuration described above. The configuration shown in FIG. 6B may be used, for example, to instrument multiple end effectors from a single sensor interface module.

FIG. 6C is a block diagram illustrating an example of a configuration and use of a sensor interface in an embodiment of a modular force/torque sensor system. In the example shown, sensor interface 642 is connected via both sensor ports A and B to sensor stack 644. In various embodiments, sensors having the FzTxTy and FxFyTz topologies can be combined by stacking an FxFyTz load cell with a FzTxTy loadcell, as in the example shown, or by integrating both sets of strain gauges into a single sensor. When combined, these topologies offer a full 6-axis sensing solution that can provide force and torque sensing in the x-, y-, and z-axes.

FIG. 6D is a block diagram illustrating an example of a configuration and use of a sensor interface in an embodiment of a modular force/torque sensor system. In the example shown, sensor interface 662 is connected to receive analog output signals from sensors 664 and 668. Sensor interface 662 is connected in series (chained) to sensor interface 672 connected to sensors 674 and 676. In various embodiments, the configuration shown in FIG. 6D may be used to provide power to and/or communication with sensors associated with two or more sensor interfaces, e.g., sensor interfaces 662, 672, in the example shown, via a single power supply and/or EtherCAT connection/cable. Such a configuration may be useful, for example, where two or more robotic arms are provided on a single base or mobile chassis and/or when a single robotic arm is equipped with two or more end effectors.

In various embodiments, as an EtherCAT device with output ports for both power and EtherCAT, a sensor interface/acquisition module as disclosed herein can be daisy-chained with additional acquisition modules or other EtherCAT devices, as in the example shown in FIG. 6D. Power and network connections are provided on the acquisition module such that it can be seamlessly daisy-chained with other acquisition modules of the same kind, or other industrial automation devices, in various embodiments.

In some embodiments, to provide well-conditioned data to the robot control system, the acquisition module contains hardware and software filters that reject unwanted noise from the load cell system.

In various embodiments, load cells can be arranged in customized positions to suit the needs of any force sensing application. For instance, a tray gripper could use load cells to sense forces on individual fingers touching a payload (e.g., tray), or to sense the weight of the entire gripper assembly. In some situations, these individual force vectors can be put through a transform selected, e.g., by applying trigonometry, to yield other forces or torques of interest.

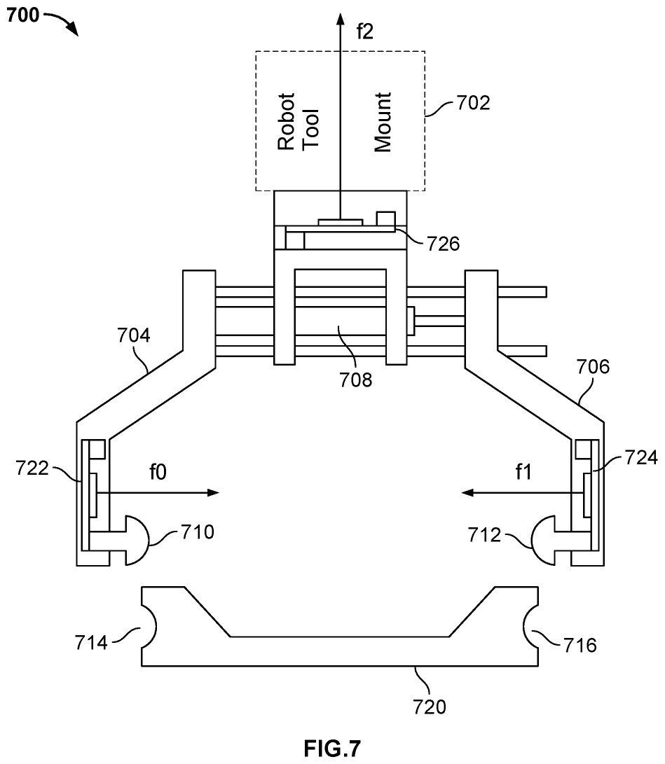

FIG. 7 is a diagram illustrating an example of a robotic end effector having load cells positioned in custom locations and/or orientations, in an embodiment of a modular force/torque sensor system. In the example shown, end effector 700 comprises robot/tool mount 702, e.g., by which the end effector 700 may be mounted to a robotic arm (not shown in FIG. 7). The end effector 700 includes a fixed arm 704 and a movable arm 706 configured to be moved relative to fixed arm 704 by operation of piston (or other linear drive mechanism) 708. Piston 708 may be operated, for example, under robotic control to open the arms 704, 706 to an open position, in which the arms 704, 706 are widely spaced enough to enable the engagement thumbs 710, 712 to be positioned on opposite sides of tray (or another object) 720. The robotic control system (not shown) may be configured to use forces and/or moments to engage thumb 710 with recess 714 of tray 720 and/or to engage thumb 712 with recess 716 of tray 720, e.g., to grasp tray 720.

In the example shown, end effector 700 is equipped with a custom 3-axis load cell array that includes load cell 722, positioned on arm 704 near thumb 710 and oriented to sense/measure force f₀ normal to an inner face of arm 704; load cell 724, positioned on arm 706 near thumb 712 and oriented to sense/measure force f₁ normal to an inner face of arm 706; and load cell 726, positioned at or near mount 702 and oriented to measure force f2 along a central vertical axis of the end effector 700.

In various embodiments, the forces f₀, f₁, and f2 measured by load cells 722, 724, and 726, respectively, are provided as analog signals to a sensor interface as disclosed herein. The sensor interface provides the force values to a control computer configured to use the force values to control operation of end effector 700 and/or a robotic arm on which the end effector 700 is mounted to perform an operation, such as to grasp, move, and place the tray 720. In various embodiments, the control computer may use the forces f₀, f₁, and f2 directly and/or may use one or more of them to compute one or more different forces and/or moments to be used to provide robotic control.

Techniques disclosed herein may be used, in various embodiments, to provide a modular system to sense, communicate, and transform sensed force values to compute force and torque values needed to provide automated control of a robotic arm or other robot or industrial component, device, or system.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A sensor interface device, comprising:
a first communication interface configured to receive an analog output associated with a sensor located remotely from the sensor acquisition device;
a processor configured to use the analog output associated with the sensor to generate a sequence of discrete values derived from the analog output associated with the sensor; and
a second communication interface coupled to the processor and configured to send at least a subset of the sequence of discrete values derived from the analog output associated with the sensor to a control module.

2. The device of claim 1, wherein the sensor comprises a force/torque sensor.

3. The device of claim 1, wherein the sensor comprises a load cell.

4. The device of claim 1, wherein the sensor comprises a plurality of load cells.

5. The device of claim 4, wherein each of the plurality of load cells comprises one or more strain gauges.

6. The device of claim 4, wherein the plurality of load cells comprises three load cells, each arranged on a respective corresponding side of an equilateral triangle.

7. The device of claim 6, wherein each of the three load cells is oriented to measure force in a same z-axis direction.

8. The device of claim 7, wherein the control module is configured to use the discrete values to compute one or more of an associated force in the z-axis direction, torque about an x-axis, and torque about a y-axis.

9. The device of claim 6, wherein each of the three load cells is oriented to measure force in a different direction along an axis that is orthogonal to a substantially planar substrate of the load cell and which extends radially outward from a z-axis of the sensor.

10. The device of claim 9, wherein the control module is configured to use the discrete values to compute one or more of an associated force in an x-axis direction, an associated force in a y-axis direction, and a torque about the z-axis of the sensor.

11. The device of claim 1, wherein the control module is configured to use the discrete values to compute one or more of a force and a moment.

12. The device of claim 11, wherein the control module is further configured to use one or both of the computed force and the computed moment to determine a control action to control a robotic device the control module is configured to control.

13. The device of claim 12, wherein the robotic device comprises a robotic arm.

14. The device of claim 13, wherein the robotic arm is equipped with an end effector at a free moving distal end of the robotic arm and the sensor is mounted at or near a mount structure by which the end effector is mounted to the robotic arm.

15. The device of claim 1, wherein the sensor comprises a first sensor, the analog output comprises a first analog output, and the device further comprises a third communication interface configured to receive a second analog output associated with a second sensor located remotely from the sensor acquisition device.

16. The device of claim 1, wherein the sensor interface device comprises a first sensor interface device, the sensor comprises a first sensor, and the analog output comprises a first analog output; and wherein the first sensor interface device further comprises a third communication interface coupled to the processor and configured to receive from a second sensor interface a network communication comprising data generated by the second sensor interface based on a second analog output received by the second sensor interface from a second sensor associated with the second sensor interface.

17. The device of claim 1, wherein the sensor comprises a stack of sensors, each sensor in the stack comprising one or more load cells arranged and oriented in a manner associated with that sensor.

18. The device of claim 1, wherein the sensor comprises a plurality of load cells, each located at a corresponding position and each oriented as a corresponding orientation.

19. A method, comprising:
receiving at a sensor acquisition device, via a first communication interface, an analog output associated with a sensor located remotely from the sensor acquisition device;
using the analog output associated with the sensor to generate a sequence of discrete values derived from the analog output associated with the sensor; and
sending to a control module, via a second communication interface, at least a subset of the sequence of discrete values derived from the analog output associated with the sensor.

20. A computer program product embodied in a non-transitory computer readable medium and comprising computer instructions for:
receiving at a sensor acquisition device, via a first communication interface, an analog output associated with a sensor located remotely from the sensor acquisition device;
using the analog output associated with the sensor to generate a sequence of discrete values derived from the analog output associated with the sensor; and
sending to a control module, via a second communication interface, at least a subset of the sequence of discrete values derived from the analog output associated with the sensor.
